(19) United States
(12) Patent Application Publication
(10) Pub. No.: US 2017/0186036 A1
(43) Pub. Date: Jun. 29, 2017

(54) MERCHANT ALERT SYSTEM AND RELATED METHOD

(71) Applicant: MasterCard International Incorporated, Purchase, NY (US)

(72) Inventors: JEREMY PASTORE, Brooklyn, NY (US); SUKANYA MISRA, Gurgaon (IN); QIAN WANG, Ridgefield, CT (US); MATTHEW HAISLEY, Monroe, NY (US); LORI DISCALA, Purchase, NY (US)

(21) Appl. No.: 14/982,199

(22) Filed: Dec. 29, 2015

(51) Int. Cl. G06Q 30/02; H04L 29/08

(52) U.S. Cl. CPC G06Q 30/0257; G06Q 30/0259; H04L 67/306

(57) ABSTRACT

A method is provided for alerting the establishment of new merchants to a user. The method generally includes parsing transactions processed over at least one payment device network, using a computing processing unit, to extract financial transaction data. By evaluating the extracted financial transaction data and comparing the extracted data with data stored in one or more databases, candidate new merchants may be determined. For an identified candidate new merchant, user-defined preferences are compared with details of the new merchant database to determine if a match exists. In response to determining a match in the new merchant database, an alert notification is generated and sent to the user using user contact information.

### FIELD OF THE DISCLOSURE

The present disclosure relates to systems and methods for providing alert notifications to potential consumers, and more particularly, to systems and methods for providing alert notifications to potential consumers when new businesses/stores open up in designated geographical locations.

### BACKGROUND OF THE DISCLOSURE

In crowded urban neighborhoods, new businesses or stores (“new merchants”), such as restaurants and clothing stores, open up on a regular basis. Conventional means of discovering these new openings of merchants in certain geographical locations include searching the Internet using search engines such as Google, exploring neighborhoods for new merchants, obtaining new merchants information from others such as neighbors or friends, searching conventional business directories such as Yellow pages and encountering new merchants' advertisements on local magazines or newsletters. Thus, unless consumers are proactive and specifically looking for new merchants in their locations of interest, it is often difficult for them to be informed of new merchants in their locations of interest.

### SUMMARY OF THE DISCLOSURE

According to an embodiment of the present disclosure, a method for alerting the establishment of new merchants to a user includes operatively linking a computing processing unit to at least one payment device network; parsing transactions processed over the at least one payment device network, using the computing processing unit, to extract financial transaction data, wherein the financial transaction data representing, where present, for each of the transactions, an associated merchant category code, an associated merchant name and an associated merchant address; comparing, using a database management system, one or more of the associated merchant category code, the associated merchant name and the associated merchant address for each of the parsed transactions with data structures stored in one or more databases containing merchant related information to identify any matches, wherein, if no matches are identified for a particular of the parsed transactions, then identifying a candidate new merchant having associated therewith details including, where present, the associated merchant category, the associated merchant name and the associated merchant address; comparing, using the database management system, the details of the candidate new merchant with data structures stored in one or more databases containing user-defined preferences to identify any matches; if a match for comparing the candidate new merchant with the user-defined preferences exists for an identified user, generating, using an alert notification unit, an alert notification based on the match, the alert notification including details related to the candidate new merchant; and transmitting, using the alert notification unit, the alert notification to the identified user.

A system for alerting the establishment of new merchants to a user, the system includes one or more database management systems, one or more computing processing units (CPUs), a member unit and an alert notification unit. Each of the one or more database management systems includes a user account database, a new merchant database and an alert database. The user account database is configured to store data associated with the user. The new merchant database is configured to store data associated with new merchants. The alert database is configured to store data associated with new merchants identified according to user-defined preferences. The one or more computing processing units are configured to monitor financial transactions being transmitted over one or more payment device networks and to compare the financial transactions with data structures in the databases containing merchant related information. The member unit is configured to provide a graphical user interface for the user to register to the system and to create and manage a user account profile. The alert notification unit is configured to generate an alert notification based on the new merchants and deliver the alert notification to the user.

These and other aspects of the present disclosure will be better understood in view of the drawings and following detailed description.

### BRIEF DESCRIPTION OF THE DRAWINGS

FIG. 1 illustrates schematically the process and parties typically involved in consummating a cashless transaction;

FIG. 2 is a block diagram of a system according to an embodiment of the present disclosure; and

FIG. 3 is a flowchart of a method for delivering new merchant alert notifications according to the present disclosure.

### DETAILED DESCRIPTION OF PREFERRED EMBODIMENTS

The following sections describe exemplary embodiments of the present disclosure. It should be apparent to those skilled in the art that the described embodiments of the present disclosure are illustrative only and not limiting, having been presented by way of example only. All features disclosed in this description may be replaced by alternative features serving the same or similar purpose, unless expressly stated otherwise. Therefore, numerous other embodiments of the modification thereof are contemplated as falling within the scope of the present disclosure as defined herein and equivalents thereto.

Throughout the description, where items are described as having, including, or comprising one or more specific components, or where methods are described as having, including, or comprising one or more specific steps, it is contemplated that, additionally, there are items of the present disclosure that consist essentially of, or consist of, the one or more recited components, and that there are methods according to the present disclosure that consist essentially of, or consist of, the one or more recited processing steps.

The present disclosure is described below with reference to flowchart illustrations and/or block diagrams of methods, apparatuses (systems), and computer program products according to embodiments of the disclosure. It will be understood that each block of the flowchart illustrations and/or block diagrams, and combinations of blocks in the flowchart illustrations and/or block diagrams, may be implemented by computer program instructions.

Providing of such computer program instructions to the “server,” “device,” “computing device,” “general purpose computer,” “computer device,” “system,” or “specialized computing device” causes a machine to be produced, such that the computer program instructions when executed create means for implementing the functions/acts specified in the flowchart and/or block diagram block or blocks. These computer program instructions may also be stored in a computer-readable medium that may direct a computer or other programmable data processing apparatus to function in a particular manner, such that the instructions stored in the computer-readable medium produce an article of manufacture including instruction means which implement the function/act specified in the flowchart and/or block diagram block or blocks.

The present disclosure is not necessarily limited to any particular number, type or configuration of processors, nor to any particular programming language, memory storage format or memory storage medium.

As used herein, a “payment device network” refers to a network or system such as the systems operated by MasterCard International Incorporated, or other networks, which electronically process payment transactions on behalf of merchants, acquirers, issuers and cardholders. The payment device network acts as an intermediary between these parties, such as between acquirers and issuers. The payment device network may include a network of operatively linked computer processing units (CPUs).

As used herein, “financial transactions” refers to all debit and credit transactions, including, but not limited to, those based on payment cards, fobs (or other near-field-communication (NFC) devices), cellular phones, smartphones, and web-enabled systems.

As used herein, “transaction data” refers to data associated with any recorded cashless transaction, including any transaction using a payment device, for example, a credit card, debit card, PIN debit card, ATM card, electronic funds transfer (EFT), near field communications (NFC) payments, smartphone wallet transactions, and so on, as well as those electronic payments using ACH and electronic wire.

As used herein, “ISO 8583” refers to standard message formatting that strings together the data elements related to a financial transaction (including merchant category, merchant name or other product identifiers of purchased items) for transmission and processing over the payment device network.

The subject disclosure involves analyzing information collected over a payment device network. The system of the subject invention may be utilized to monitor purchases of consumers to determine new merchants in given geographical locations. It is noted that any form of payment over a payment device network may be utilized within the system. Preferably, the monitoring and determination of the new merchants shall be conducted in real-time to incorporate latest activities.

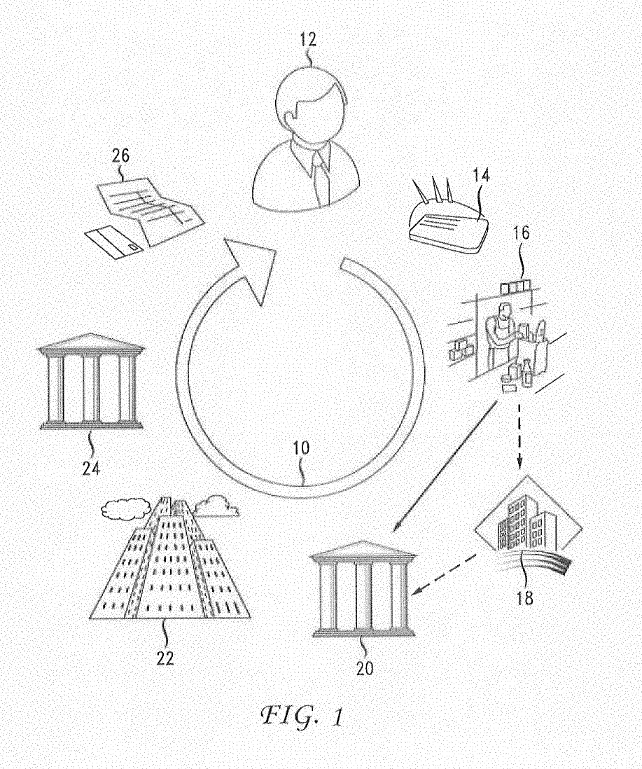

The process and parties typically involved in consummating a cashless payment transaction can be visualized for example as presented in FIG. 1, and can be thought of as a cycle, as indicated by arrow 10. A device holder 12 may present a payment device 14, for example a payment device, transponder device, NFC-enabled smart phone, among others and without limitation, to a merchant 16 as payment for goods and/or services. For simplicity the payment device 14 is depicted as a payment card, although those skilled in the art will appreciate the present disclosure is equally applicable to any cashless payment device, for example and without limitation, contactless RFID-enabled devices including smart cards, NFC-enabled smartphones, electronic mobile wallets or the like. The payment device 14 here is emblematic of any transaction device, real or virtual, by which the device holder 12 as payor and/or the source of funds for the payment may be identified.

In cases where the merchant 16 has an established merchant account with an acquiring bank (also called the acquirer) 20, the merchant communicates with the acquirer to secure payment on the transaction. An acquirer 20 is a party or entity, typically a bank, which is authorized by the network operator 22 to acquire network transactions on behalf of customers of the acquirer 20 (e.g., merchant 16). Occasionally, the merchant 16 does not have an established merchant account with an acquirer 20, but may secure payment on a transaction through a third-party payment provider 18. The third party payment provider 18 does have a merchant account with an acquirer 20, and is further authorized by the acquirer 20 and the network operator 22 to acquire payments on network transactions on behalf of sub-merchants. In this way, the merchant 16 can be authorized and able to accept the payment device 14 from a device holder 12, despite not having a merchant account with an acquirer 20.

The acquirer 20 routes the transaction request to the network operator 22. The data included in the transaction request will identify the source of funds for the transaction. With this information, the network operator 22 routes the transaction to the issuer 24. An issuer 24 is a party or entity, typically a bank, which is authorized by the network operator 22 to issue payment devices 14 on behalf of its customers (e.g., device holder 12) for use in transactions to be completed on the network. The issuer 24 also provides the funding of the transaction to the network provider 22 for transactions that it approves in the process described. The issuer 24 may approve or authorize the transaction request based on criteria such as a device holder's credit limit, account balance, or in certain instances more detailed and particularized criteria including transaction amount, merchant classification, etc., which may optionally be determined in advance in consultation with the device holder and/or a party having financial ownership or responsibility for the account(s) funding the payment device 14, if not solely the device holder 12.

The decision made by the issuer 24 to authorize or decline the transaction is routed through the network operator 22 and acquirer 20, ultimately to the merchant 16 at the point of sale. This entire process is typically carried out by electronic communication, and under routine circumstances (i.e., valid device, adequate funds, etc.) can be completed in a matter of seconds. It permits the merchant 16 to engage in transactions with a device holder 12, and the device holder 12 to partake of the benefits of cashless payment, while the merchant 16 can be assured that payment is secured. This is enabled without the need for a preexisting one-to-one relationship between the merchant 16 and every device holder 12 with whom they may engage in a transaction.

The issuer 24 may then look to its customer, e.g., device holder 12 or other party having financial ownership or responsibility for the account(s) funding the payment device 14, for payment on approved transactions, for example and without limitation, through an existing line of credit where the payment device 14 is a credit card, or from funds on deposit where the payment device 14 is a debit card. Generally, a statement document 26 provides information on the account of a device holder 12, including merchant data as provided by the acquirer 20 via the network operator 22.

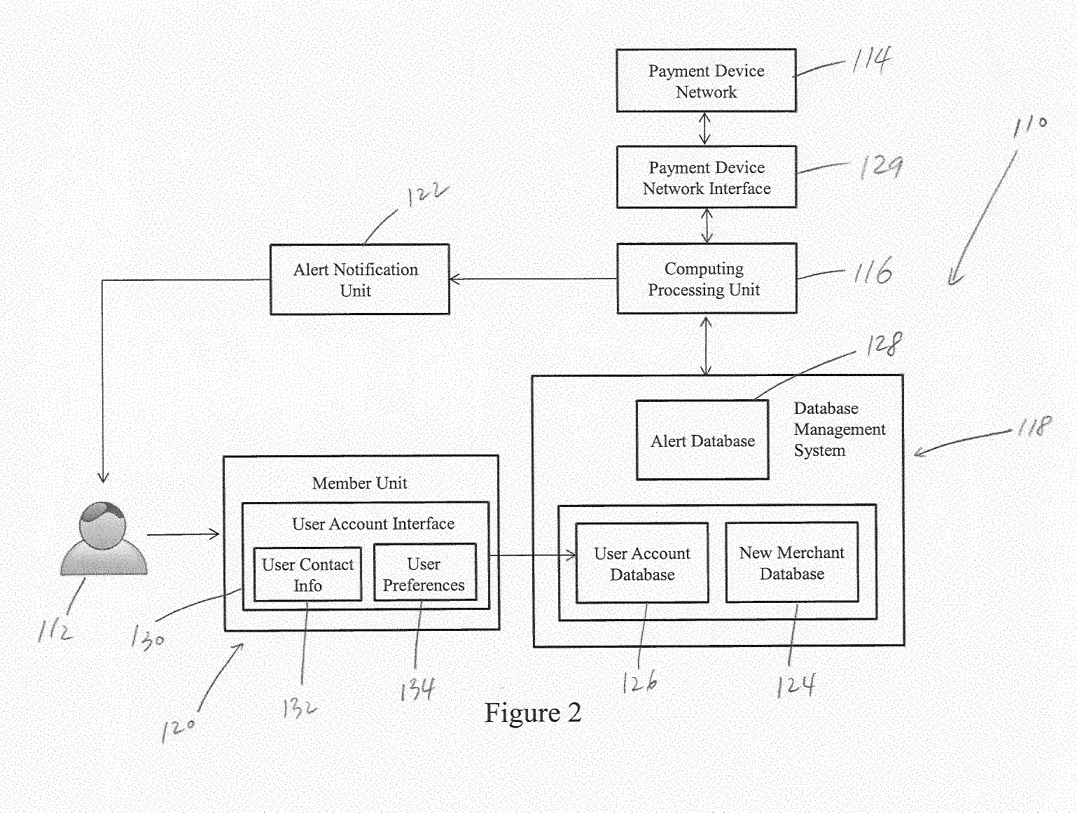

FIG. 2 provides an illustrative representation of a system 110 according to the present disclosure. The system 110 is configured to allow the users (prospective consumers) 112 of the system 110 to easily and conveniently track new merchants, such as restaurants, bars, retailers, etc., in one or more given geographical locations by delivering alert notifications containing information related with the new merchants. The system 110 confers benefits not only to the users 112, but also to both the new merchants and payment device network operator (an intermediary between acquirers and issuers). For example, by delivering new merchant alert notifications to the users 112, the system 110 may entice them to purchase goods and/or services from the new merchants thus, naturally, providing potential financial benefits to both the new merchants and the payment device network operator.

The system 110 operates in conjunction with one or more payment device networks 114. As will be appreciated by those skilled in the art, any payment device network may be utilized, including traditional networks which communicate between merchants, acquirers, and issuers to authorize and clear consumer debit and credit transactions (e.g., Automated Clearing House (ACH) network). The subject invention may be used with other systems for authorizing and clearing debit and credit transactions via wireless devices such as smartphones or web-enabled applications.

Referring again to FIG. 2, the system 110 according to the present disclosure generally includes one or more computing processing units (CPUs) 116, one or more database management systems 118, a member unit 120 and an alert notification unit 122. The one or more database management systems 118 are configured to manage a plurality of databases, including, but not limited to, a new merchant database 124, a user account database 126 and an alert database 128. Alternately, each of the plurality of databases 124, 126, 128 may be separately managed by individual database management systems 118.

Each CPU 116 is operatively linked, hard wired and/or wirelessly, to the one or more payment device networks 114. Each of the payment device networks 114 is a network of specialized computing devices that are operatively linked (hard-wired, wirelessly, etc.) to allow for secure transmission of financial transaction details between various entities (issuers, acquirers, banks, etc.) to facilitate authorization, clearing and settlement of financial transactions.

The financial transactions may be presented to the one or more CPUs 116 in batch form, for example, periodically post-settlement from acquirers. Additionally or alternatively, a payment device network interface 129 may be utilized that allows the one or more CPUs 116 access to the one or more payment device networks 114 to review financial transactions thereon while being processed. The financial transactions may be caused to pass through the CPUs 116 by the payment device network interface 129 which intercepts the financial transactions and once again releases the financial transactions once processed through the CPUs 116.

The one or more CPUs 116 are configured to interface with the plurality of databases 124, 126, 128 in the database management system 118. The CPUs 116 are operative to act on a program or set of instructions stored in the database management system 118. Execution of the program or set of instructions causes one of the CPUs 116 to carry out tasks such as locating data, retrieving data, processing data, etc. In addition, the one or more CPUs 116 can execute the program of instructions that can identify the new merchants that meet the user-defined criteria, such as locations of interest and business categories of interest and retrieve details associated with the new merchants. The locations of interest and the business categories of interest identify designated geographical locations and business categories of the new merchants that the user 112 wants to be alerted. This process will be described in more detail below.

The new merchant database 124 may be configured to store merchant related information. More specifically, the merchant related ISO 8583 formatted data extracted from the financial transactions processed over the one or more payment device networks 114 may be processed and maintained in the new merchant database 124. The ISO 8583 formatted data may be extracted by parsing the financial transactions. The ISO 8583 formatted data may include details representing, but are not limited to, merchant category, merchant name, merchant address and goods/services offered. Furthermore, the new merchant database 124 may be configured to store merchant details from any data sources such as payment network device operator's data warehouses, data feeds from third-parties (e.g., issuers, acquirers, etc.).

The user account database 126 is configured to store information associated with the registered users 112 of the system. The information pertaining to the registered users 112 is provided by the users 112 themselves via the member unit 120, as will be described in more detail below. Fields in the user account database 126 may include, but are not limited to, user name, address, phone number, locations of interest, business categories of interest and alert notification delivery modes.

The alert database 128 is configured to store details pertaining to new merchant alert notifications that are generated by utilizing the new merchant data stored in the new merchant database 124. Examples of the details included in the new merchant alert notifications are merchant name, merchant category, merchant address, good/service offered and good/service amount.

The payment device network operator 22 may maintain operational control of the one or more database management systems 118. As described above, the data pertaining to the new merchants, registered users and alert notifications are stored in the new merchant database 124, the user account database 126 and the alert database 128, respectively. Alternatively, all of the data may be stored and maintained in one database. The databases 124, 126, 128 may be implemented with plural, several, shared, divided and/or redundant machines as the network operator 22 finds necessary or convenient, including the necessary operational capacity to divide the processing of volumes of transactions and/or access to data entries among such plural machines, etc.

The member unit 120 includes a graphical user interface (GUI), more specifically, a user account interface 130 capable of capturing various user provided data. The user account interface 130 allows a user 112 to register with the system 110 by creating a user account profile, using his/her existing e-mail address. Alternatively, the user account profile can be easily established by linking and accessing one of the user's existing social networking website account profiles, such as Facebook®, Twitter® or LinkedIn®. Once the user registration process is completed, the user 112 may log into the system 110 with the authentication credentials established (e.g., username and password) and automatically receives new merchant alert notifications until the user membership is voluntarily cancelled by the user 112.

The user account interface 130 includes two main sections; a user contact information section 132 and a user preference section 134. The user contact information section 132 is capable of capturing the user-related information needed to establish the user membership with the system 110. Examples of the user contact information are user first name, user last name, account name, e-mail, phone number, etc. With the user account interface 130, the user 112 can access and manage (add, update or delete) any user contact information saved in the user account profile.

In the user preference section 134, a location entry for the user 112 to specify one or more geographical locations of interest is provided. For example, to designate geographical locations of interest, the user 112 can simply enter either zip codes or combinations of city and state in the location entry. The user preference section 134 further provides a selectable listing of business categories to allow the user 112 to select/deselect one or more of business categories of interest. Once both the locations and business categories are specified and entered into the system 110, the system 110 will monitor and generate new merchants that satisfy the user-defined locations and business categories. In addition, in the user preference section 134, one or more alert notification delivery options such as, but not limited to, e-mails, fax, texts, RSS (Rich Site Summary), may be specified by the user 112.

As stated above, the user 112 can specify one or more geographical locations of interest and one or more business categories of interest. For example, the geographical locations of interest may be localities that are close to the user's place of residence or workplace, such as Soho, N.Y. (residence) and Greenwich Village, N.Y. (work). Additionally, examples of the business categories of interest may be restaurants, movie theaters, bars, retailers (e.g., clothing stores), etc. Once the user 112 has provided and submitted all the necessary information (e.g., user contact information, locations, business categories, alert notification delivery modes), the member unit 120 collects the user input data and stores the information in the user account database 126.

It will be appreciated by one skilled in the art that although the user 112 can specify geographical locations of interest and business categories of interest as criteria for receiving new merchant alert notifications, the present disclosure is not limited to only locations and business categories. For example, the user 112 may also specify additional information, such as products of interest (e.g., books, toys, electronics, etc.). Furthermore, the geographical locations of interest are not limited only to the residence and workplace, but may be any locations of interest to the user 112.

The member unit 120 can be implemented as a stand-alone application on both a web-based platform (online/Internet web application) and mobile-based platform (mobile application) such that the users 112 may access it over the Internet using a computing device that includes a display and an input device implemented therein. Non-limiting examples of computing devices include a personal computer (laptop or desktop), mobile phone (smartphones), tablets, personal digital assistants (PDA), or other similar devices. The computer devices will typically access the system 110 directly through an Internet service provider (ISP) or indirectly through another network interface.

The alert notification unit 122 may be designed and configured to generate and transmit new merchant alert notifications that include details associated with the new merchants. Such details include, but are not limited to, merchant name, merchant category, merchant address and goods/services offered. The alert notification unit 122 may receive, via CPU 116, information regarding new merchants from the alert database 128 within the database management system 118 and then transmit the new merchant alert notifications to the user 112 via one of the methods that are prevalent in the relevant art, such as e-mail, SMS, applications (mobile or web), etc.

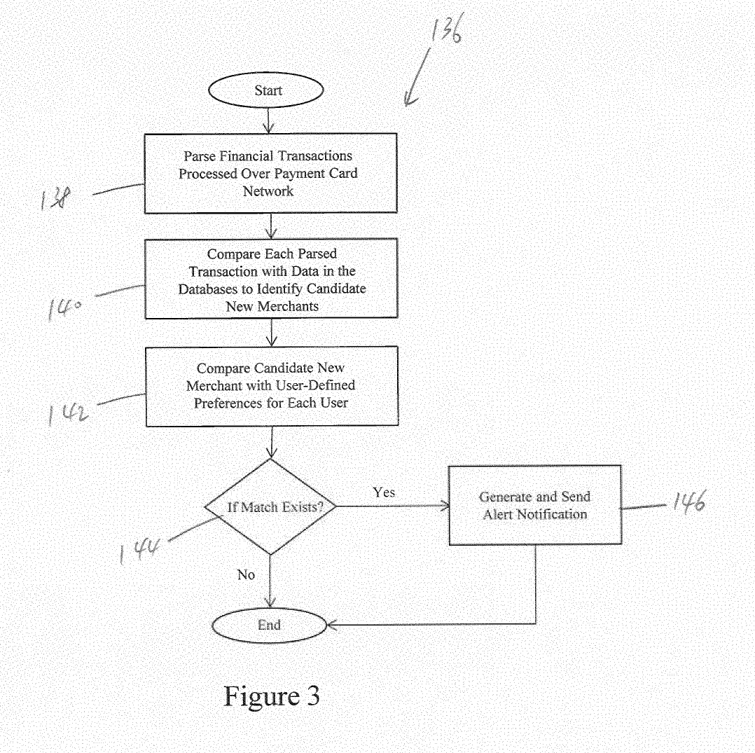

Referring to FIG. 3, a method 136 for alerting the establishment of new merchants to a user 112 will be described. The method 136 may be a real-time method that enables the system 110 to identify candidate new merchants in accurately and timely manner to provide new merchants associated with the user-defined preferences for each user 112. For example, when a consumer makes a purchase at a newly established merchant using his/her payment card, merchant alert notifications, which reflect the purchase at the newly established merchant, will be regenerated.

In a first step 138, the one or more CPUs 116 may parse financial transactions processed over the one or more one payment device networks 114 to extract ISO 8583 formatted data. As stated above, for each of the parsed financial transactions, the extracted ISO 8583 formatted data may include information representing, but are not limited to, merchant category, merchant name, merchant address and goods/services offered. In addition, the detailed merchant particulars may be included in optionally-used data elements, e.g., Level II and Level III data, as is known to those skilled in the art.

In a second step 140, the parsed financial transactions in the first step 138 may be used to determine candidate new merchants to be compared with the user-defined preferences stored in the user account database 126. More specifically, the one or more CPUs 116 compare each parsed financial transactions, containing the associated merchant category code, the associated merchant name and the associated merchant address, with data structures stored in the databases 124, 126, 128 containing merchant related information to identify if any matching merchants exist. The merchant related information (e.g., merchant category, merchant name, merchant address, etc.) may be contained in the new merchant database 124. If no matches are found for the merchant details for a particular parsed financial transaction, then the merchant associated with the particular parsed financial transaction is identified as a candidate new merchant. This matching process is repeated for all parsed financial transactions to generate a complete list of candidate new merchants to be compared with the user-defined preferences.

In a third step 142, the candidate new merchants identified in the second step 140 may be compared with the user-defined preferences for each user 112. The one or more CPUs 116 continuously execute programs or sets of instructions, which may include algorithms, to compare the details of each candidate new merchant with data structures stored in one or more databases 124, 126, 128 containing user-defined preferences to identify if any matches exist. For examples, when the user 112 specifies “Restaurant” and “Movie Theaters” as the business categories of interest and “Soho, N.Y.” as the location of interest, the CPUs 116 execute the programs of instructions to identify from the list of the candidate new merchants for any new restaurants and movie theaters in Soho, N.Y. and its vicinities. In other words, the program searches for new restaurants and movie theatres in the user-defined location of interest, Soho, N.Y., as well as in its surrounding neighborhoods, such as Tribeca, N.Y. When the system 110 determines that there is a match(s) 144 in the list of candidate new merchants, the details associated with the match(s) are routed to the alert notification unit 122. The matched candidate new merchants may be stored in the new merchant database 124.

In a fourth step 146, the alert notification unit 122 generates a new merchant alert notification based on the matched candidate new merchants. If there are no matched candidate new merchants, no new merchant alert notification will be generated. Thereafter, the alert notification unit 122 transmits the generated new merchant alert notification to the user 112 via the delivery modes specified by the user 112.

Techniques consistent with the present disclosure provide, among other features, systems and methods for transmitting new merchant alert notifications to users. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for alerting the establishment of new merchants to a user, the method comprising:
operatively linking a computing processing unit to at least one payment device network;
parsing transactions processed over the at least one payment device network, using the computing processing unit, to extract financial transaction data, wherein the financial transaction data representing, where present, for each of the transactions, an associated merchant category code, an associated merchant name and an associated merchant address;
comparing, using a database management system, one or more of the associated merchant category code, the associated merchant name and the associated merchant address for each of the parsed transactions with data structures stored in one or more databases containing merchant related information to identify any matches, wherein, if no matches are identified for a particular of the parsed transactions, then identifying a candidate new merchant having associated therewith details including, where present, the associated merchant category, the associated merchant name and the associated merchant address;
comparing, using the database management system, the details of the candidate new merchant with data structures stored in one or more databases containing user-defined preferences to identify any matches;
if a match for comparing the candidate new merchant with the user-defined preferences exists for an identified user, generating, using an alert notification unit, an alert notification based on the match, the alert notification including details related to the candidate new merchant; and
transmitting, using the alert notification unit, the alert notification to the identified user.

2. The method of claim 1, wherein the comparing includes the associated merchant address of the candidate new merchant with locations or geographical areas included in the data structures containing the user-defined preferences.

3. The method of claim 1, wherein the user-defined preferences include a plurality of locations of interest and a plurality of business categories of interest.

4. The method of claim 3, wherein the plurality of locations of interest identify designated geographical locations of the new merchants which the user wants to be alerted.

5. The method of claim 3, wherein the plurality of business categories of interest identify business categories of the new merchants which the user wants to be alerted.

6. The method of claim 1, wherein the financial transaction data is ISO 8583 formatted data.

7. The method of claim 1, wherein the alert notification unit is configured to deliver the alert notification by one or more delivery modes including emails, fax, texts and RSS.

8. A non-transitory machine-readable recording medium storing thereon a program of instruction which, when executed by a processor, cause the processor to:
parse transactions processed over the at least one payment device network, using the computing processing unit, to extract financial transaction data, wherein the financial transaction data representing, where present, for each of the transactions, an associated merchant category code, an associated merchant name and an associated merchant address;
compare, using a database management system, one or more of the associated merchant category code, the associated merchant name and the associated merchant address for each of the parsed transactions with data structures stored in one or more databases containing merchant related information to identify any matches, wherein, if no matches are identified for a particular of the parsed transactions, then identify a candidate new merchant having associated therewith details including, where present, the associated merchant category, the associated merchant name and the associated merchant address;
compare, using the database management system, the details of the candidate new merchant with data structures stored in one or more databases containing user-defined preferences to identify any matches;
if a match for comparing the candidate new merchant with the user-defined preferences exists for an identified user, generate, using an alert notification unit, an alert notification based on the match, the alert notification including details related to the candidate new merchant; and
transmit, using the alert notification unit, the alert notification to the identified user.

9. The method of claim 8, wherein the comparing includes the associated merchant address of the candidate new merchant with locations or geographical areas included in the data structures containing the user-defined preferences.

10. The method of claim 8, wherein the user-defined preferences include a plurality of locations of interest and a plurality of business categories of interest.

11. The method of claim 10, wherein the plurality of locations of interest identify designated geographical locations of the new merchants which the user wants to be alerted.

12. The method of claim 10, wherein the plurality of business categories of interest identify business categories of the new merchants which the user wants to be alerted.

13. The method of claim 8, wherein the financial transaction data is ISO 8583 formatted data.

14. The method of claim 8, wherein the alert notification unit is configured to deliver the alert notification by one or more delivery modes including emails, fax, texts and RSS.

15. A system for alerting the establishment of new merchants to a user, the system comprising:
one or more database management systems, each of the one or more database management systems including:
a user account database configured to store data associated with the user,
a new merchant database configured to store data associated with new merchants, and
an alert database configured to store data associated with new merchants identified according to user-defined preferences;
one or more computing processing units configured to monitor financial transactions being transmitted over one or more payment device networks and to compare the financial transactions with data structures in the databases containing merchant related information;
a member unit configured to provide a graphical user interface for the user to register to the system and to create and manage a user account profile; and
an alert notification unit configured to generate an alert notification based on the new merchants and deliver the alert notification to the user.

16. The system according to claim 15, wherein the user-defined preferences include a plurality of locations of interest and a plurality of business categories of interest.

17. The system according to claim 16, wherein the plurality of locations of interest identify designated geographical locations of the new merchants which the user wants to be alerted.

18. The system according to claim 16, wherein the plurality of business categories of interest identify business categories of the new merchants which the user wants to be alerted.

19. The system according to claim 15, wherein the user account profile contains user-related details, including at least user contact information, the plurality of locations of interest of the user, the plurality of business categories of interest of the user and user-preferred alert notification delivery modes.

20. The system according to claim 19, wherein the user-related details may be added, updated or deleted by the user via a user account profile interface of the member unit.
